(19) United States
(12) Patent Application Publication
(10) Pub. No.: US 2018/0223178 A1
(43) Pub. Date: Aug. 9, 2018

(54) RENEWABLE DIESEL BASE FLUIDS FOR USE IN SUBTERRANEAN FORMATION OPERATIONS

(71) Applicant: Halliburton Energ Services, Inc., Houston, TX (US)

(72) Inventors: Jeffrey J. MILLER, Spring, TX (US); Shane WISE, The Woodlands, TX (US); Shubhajit GHOSH, Houston, TX (US)

(21) Appl. No.: 15/748,166

(22) PCT Filed: Jul. 14, 2015
(86) PCT No.: PCT/US2015/040353

§ 371 Date: Jan. 26, 2018

(51) Int. Cl. C09K 8/82; C09K 8/58; C09K 8/74; C09K 8/528; C09K 8/60

(52) U.S. Cl. CPC C09K 8/82; C09K 8/58; C09K 8/74; C09K 8/528; C09K 2208/32; C09K 2208/12; C09K 2208/22; C09K 2208/26; C09K 8/605

(57) ABSTRACT

Treatment fluids including a renewable diesel base fluid comprising in the range of about 10% and about 67.5% C18 hydrocarbons by weight of the base fluid; and at least one treatment fluid additive. Methods including introducing the treatment fluid into a subterranean formation and performing a subterranean formation operation thereof.

### BACKGROUND

The present disclosure relates to subterranean formation operations and, more particularly, to treatment fluids comprising renewable oil diesel for use in a subterranean formation operation.

Hydrocarbon producing wells (e.g., oil and gas wells) are typically formed by drilling a wellbore into a subterranean formation. A drilling treatment fluid is circulated through a tubular (e.g., a drill string) and contacted with a drill bit within the wellbore as the wellbore is being drilled. The drilling treatment fluid is produced back to the surface of the wellbore with drilling cuttings for removal from the wellbore. The drilling treatment fluid maintains a specific, balanced hydrostatic pressure within the wellbore, permitting all or most of the drilling fluid to be produced back to the surface.

After a wellbore is drilled, a cement column may be placed around casing (or liner string) in the wellbore. In some instances, the cement column is formed by pumping a cement slurry through the bottom of the casing and out through an annulus between the outer casing wall and the formation face of the wellbore. The cement slurry then cures in the annular space, thereby forming a sheath of hardened cement that, inter alia, supports and positions the casing in the wellbore and bonds the exterior surface of the casing to the subterranean formation. This process is referred to as “primary cementing.” Among other things, the cement column may keep fresh water zones from becoming contaminated with produced fluids from within the wellbore, prevent unstable formations from caving in, and form a solid barrier to prevent fluid loss from the wellbore into the formation and the contamination of production zones with wellbore fluids.

A spacer treatment fluid may trail (or come after) the cement slurry to maintain the hydrostatic pressure within the wellbore and clean or otherwise dilute any residual amount of cement slurry within the wellbore. That is, the spacer treatment fluid may be used to displace the cement slurry into the annulus for curing into the cement column.

Thereafter, perforation tunnels may be formed using a perforating gun (or other cutting or abrasion tool) to achieve a communication tunnel between the formation and the wellbore (including through any casing and/or cement column). Stimulation of the formation may then be performed using hydraulic fracturing treatments, for example. In hydraulic fracturing treatments, a fracturing treatment fluid is pumped into a portion of a subterranean formation at a rate and pressure such that the subterranean formation breaks down and one or more fractures are formed, which may be through the formed perforation tunnels, when appropriate. Typically, solid particles are then deposited in the fractures. These solid particles, or “proppant,” serve to prevent the fractures from fully closing once the hydraulic pressure is removed by forming a proppant pack. As used herein, the term “proppant pack” refers to a collection of proppant in a fracture. By keeping the fracture from fully closing, the proppant aids in forming conductive paths through which fluids may flow.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIGS. 1A and 1B is a full-view and zoomed-in view, respectively, hydrocarbon content chart comparing #2 petroleum diesel and a renewable diesel suitable for use in the embodiments of the present disclosure.

FIG. 2 depicts a wellbore system for performing a subterranean formation operation using the treatment fluids described herein, according to one or more embodiments of the present disclosure.

### DETAILED DESCRIPTION

The present disclosure relates to subterranean formation operations and, more particularly, to treatment fluids comprising renewable diesel for use in a subterranean formation operation.

As used herein, the term “treatment fluid,” and grammatical variants thereof, refers to a fluid designed and prepared for use in a specific subterranean formation operation. As used herein, the term “subterranean formation operation” (or simply “formation operation”), and grammatical variants thereof, refers any treatment performed at a sub-surface location in furtherance of recovering hydrocarbons. Accordingly, the term “operation” and “treatment” may be used interchangeably herein. Examples of formation operations that can employ the treatment fluids comprising renewable diesel according to the embodiments described herein may include, but are not limited to, drilling operations, pre-pad treatment operations, fracturing operations, pre-flush treatment operations, after-flush treatment operations, sand control operations (e.g., gravel packing), acidizing operations (e.g., matrix acidizing or fracture acidizing), “frac-pack” operations, water control operations, fluid loss control operation (e.g., gel pills), wellbore clean-out operations, lost circulation control operations, a completion operation, and the like, and any combination thereof.

Treatment fluids having the renewable base fluid described herein may thus include, but are not limited to, drilling treatment fluids, spacer treatment fluids, stimulation treatment fluids (e.g., for use in fracturing, acidizing, frac-packing, and the like), lost circulation treatment fluids, water control fluids, wellbore clean-out treatment fluids, lost circulation control treatment fluids, kill pill treatment fluids, and the like, and any combination thereof. As referred to herein, the term “spacer fluid” refers to a treatment fluid placed within a wellbore to separate fluids (e.g., to separate a drilling treatment fluid within the wellbore from a cement slurry) that will subsequently be placed within the wellbore. As used herein, the term “kill pill treatment fluid” (or simply “kill pill”) refers to a treatment fluid pill that when implemented prevents the influx of formation fluids into the wellbore and the loss of wellbore fluids to the formation while the well is open. As used herein, a “pill” is a type of relatively small volume of specially prepared treatment fluid placed or circulated in the wellbore.

The treatment fluids described according to the embodiments of the present disclosure comprise a renewable diesel base fluid. Diesel (or “oil”) base fluids, particularly when used in emulsion form, are beneficial in their capacity to handle rough downhole conditions (e.g., harsh temperatures, chemicals, and the like, as compared to other treatment base fluids (e.g., aqueous base fluids). They additionally provide advantages to a pumping or drilling operation including, but not limited to, faster drill rates, faster run-in rates for tubulars (e.g., any conveyance mechanically connected to the surface for delivery of a downhole component or tool), lesser torque and drag effects (e.g., in directional wellbores), lower corrosion rates, and the like. While aqueous base fluids may not perform as well as their oil base fluid counterparts, aqueous base fluids are often employed for environmental or cost reasons, although sources of water suitable for aqueous fluids are often scarce in certain areas of the world, and their use in downhole operations may divert such scarce resources from human consumption or require costly transportation of the fluids from other areas.

Renewable diesel differs significantly from traditionally used oil base fluids (referred to as “traditional oil fluids”) for use in subterranean formation operations. Such traditional oil fluids, which may be in emulsion form (e.g., invert emulsion), are generally petroleum diesel or biodiesel, although other fluids such as mineral oils and synthetic olefin oils are also used.

Petroleum diesel and biodiesel have been traditionally used in pure form or as a blended composition. Traditional petroleum diesel may be costly and environmentally or operationally objectionable in some instances. For example, the aromatic content of such petroleum diesel may pose safety risks to operators and the environment, including elevated emissions profiles. Traditional biodiesel may, in some instances, interfere adversely with some operational equipment (e.g., steel), increase food prices nationally and internationally, be susceptible to degradation and health and safety concerns due to heat and alkalinity, or react downhole to form soap-like substances that may be too thick for certain formation operations without equipment adjustments or other adjustments (e.g., added chemistry).

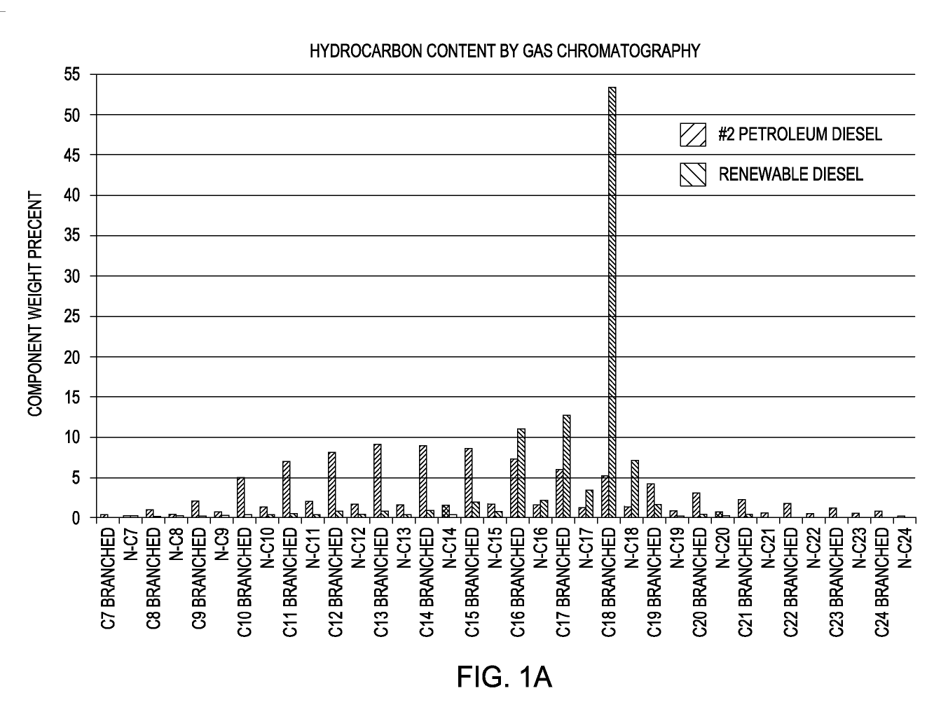

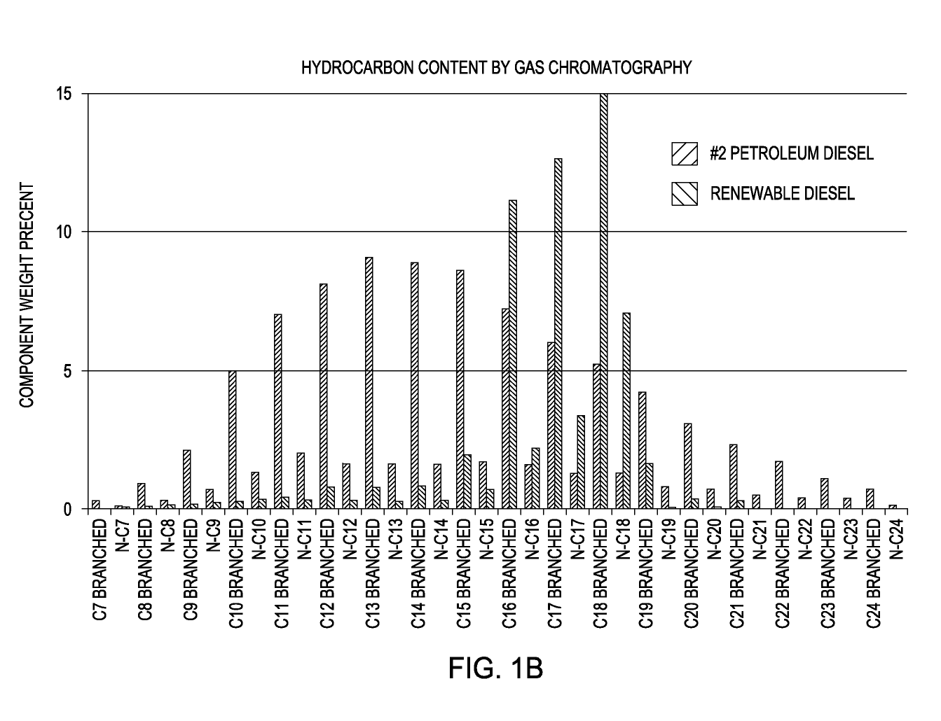

Petroleum diesel is distillate rich in paraffinic hydrocarbons and is typically produced by distillation of crude oil between 200° C. and 350° C. at atmospheric pressure, resulting in a mixture of carbon chains that typically contain between 7 carbon atoms per molecule (“C7”) and 24 carbon atoms per molecule (“C24”), which may be either branched, cyclic or straight chained. As used herein, the denotation of “C” prior to a integer refers to a molecule having that integer of carbon atoms, and the term “n-” prior to “Cn,” where n is the number of carbon atoms per molecule denotes a straight chained molecule. As mentioned, petroleum diesel is rich in paraffinic hydrocarbons, which in liquid form, as would be used in a treatment fluid for forming a formation operation, typically are C5 to C15. The hydrocarbon content of a traditional petroleum diesel is depicted in FIG. 1A, B. As shown, and discussed in greater detail below, the distribution of hydrocarbons ranges from C7 to C24, branched, cyclic and unbranched (branched and straight-chained shown), with no single hydrocarbon accounting for greater than about 10% of the petroleum diesel content.

Biodiesel, another traditionally used oil base fluid for treatment fluids used in subterranean formation operations, is produced using a transesterification process, having glycerol as a by-product. The transesterification process involves reacting lipidous biomass (i.e., animal fats and vegetable oils) catalytically with short-chained aliphatic alcohols (e.g., methanol, ethanol, and the like). Accordingly, biodiesel contains oxygen atoms, and is comprised of mono-alkyl esters of long-chain fatty acids derived from lipidous biomass.

The oil base fluid described herein, however, differs from both traditional petroleum diesel and biodiesel, referred to as renewable diesel (or “renewable oil”). Renewable diesel is markedly different from traditional petroleum diesel and biodiesel and thus represents a unique use in subterranean treatment operations. As used herein, the term “renewable diesel” (or “renewable oil”) refers to a substance derived from lipidous biomass (i.e., animal fats and vegetable oils) that are chemically not esters.

The renewable diesel for use in the embodiments of the present disclosure may be formed by a variety of processes including, but not limited to, hydrotreating, thermal depolymerization, and biomass-to-liquid processing. As used herein, the term “hydrotreating” refers to a chemical catalytic conversion process characterized by a reaction with hydrogen to remove or reduce impurities from a substance. Hydrotreating typically removes or reduces impurities including sulfur, nitrogen, oxy-compounds, chloro-compounds, aromatics (e.g., condensed ring aromatics), waxes, and metals. The term “thermal depolymerization” (also referred to as thermal processing or conversion), as used herein, refers to a depolymerization process of using hydrous pyrolysis to convert complex biomass material into short-chain hydrocarbons. As used herein, the term “biomass-to-liquid processing” refers to the chemical conversion of biomass into synthetic gas using high-temperature gasification, followed by utilization of the Fischer-Tropsch process to convert the synthetic gas into a renewable diesel. In some embodiments, it may be preferable to use a hydrotreating process, which is currently used in traditional petroleum diesel refineries.

Renewable diesel, in some embodiments, may be used as a base fluid in the treatment fluids described herein in blended form with petroleum diesel and/or petroleum distillate base fluids, without departing from the scope of the present disclosure, such as due to diesel or petroleum distillate base fluids availability, formation properties, desired base fluid properties, and the like. Such petroleum diesels and petroleum distillate base fluids (collectively referred to herein as “petroleum diesel” unless specified otherwise) may include, but are not limited to #1 diesel, #2 diesel, petroleum distillate base fluids (e.g., Group I distillate (e.g., diesel), Group II distillate, and/or Group III distillate defined by Oil and Gas Producers (OGP) classifications) and any combination thereof. Suitable commercially available petroleum diesels may include, but are not limited to, CUTTER STOCK DIESEL, a Group I distillate, available from Husky Energy in Alberta, Canada; DISTILLATE 822, a Group I distillate, available from Moose Jaw Asphalt Inc. in Saskatchewan, Canada; HY-40, a Group II distillate, available from Ergon Refining, Inc. in Jackson, Miss.; ESCAID 110, a Group III distillate, available from ExxonMobil in Irving, Tex.; EDC 99DW, a Group III distillate available from Total Fluides in Pau, France; and the like. Each of these values is critical to the embodiments of the present disclosure and may depend on a number of factors including, but not limited to, the formation conditions (e.g., the temperature of the wellbore for gelling or thickening resistance in cold environments), desired lubrication properties, desired energy content, and the like.

When a renewable diesel as described herein is blended with a petroleum diesel according to an embodiment described herein, the ratio of renewable diesel:petroleum diesel (whether pure petroleum diesel, blended, or distillates, or combinations thereof) may be in the range of about 1:100 to about 100:1 by volume. For example, the ratio may be about 1:100 to about 20:100, or about 20:100 to about 40:100, or about 40:100 to about 60:100, or about 60:100 to about 80:100, or about 80:100 to about 100:1, encompassing any value and subset therebetween, and without departing from the scope of the present disclosure. In some embodiments, for health, safety, and environmental purposes, it may be desirable to minimize aromatic content of a treatment fluid comprising renewable diesel blended with petroleum diesel, and in such embodiments, it may be desirable that the ratio of renewable diesel:petroleum diesel may be in the range of about 50:50 to about 100:1, such as about 50:50 to about 60:40, or about 60:40 to about 70:30, or about 70:30 to about 80:20, or about 80:20 to about 90:10, or about 90:10 to about 100:1, encompassing any value and subset therebetween, and without departing from the scope of the present disclosure. In some embodiments, the ratio of renewable diesel:petroleum diesel is about 50:50. Each of these values is critical to the embodiments of the present disclosure and may depend on a number of factors including, but not limited to, the formation conditions, the subterranean formation operation being performed and the like.

Referring again to FIGS. 1A and 1B, illustrated is a full chart (FIG. 1A) and a zoomed-in chart (FIG. 1B) displaying the weight percent of hydrocarbons between C7 and C24, including branched and straight chained hydrocarbons, between #2 petroleum diesel and a renewable diesel suitable for use in the embodiments of the present disclosure, as determined by gas chromatography. As shown, the #2 petroleum diesel is rich in hydrocarbons between C5 and C15, whereas the renewable diesel is primarily rich in hydrocarbons C16 to C18. Indeed, the renewable diesel for use as a base fluid in the treatment fluids of the present disclosure have notably greater amounts of C16, C17, and C18 hydrocarbons. These hydrocarbons are ideal as base fluids since they fall into a particular molecular size. Shorter chain hydrocarbons are more volatile and are known to be toxic to marine organisms. For example, these short chained hydrocarbons are believed, based on shrimp bioassay testing, to adhere to gills and cause high mortality. Longer chain hydrocarbons cause a rise precipitously in viscosity, which makes formulation of oil base fluids increasingly difficult, particularly for challenging environments like deepwater. Anywhere the application temperatures will be cold, a particular hydrocarbon range is necessary to provide suitable fluid properties for efficient well operations. Accordingly, the size of the C16-C18 hydrocarbons can provide benefits outside of these short and long hydrocarbon extremes.

Additionally, C16-C18 hydrocarbons perform well in technical aspects and environmental test batteries. C16-C18 synthetic internal olefin hydrocarbons (non-renewable) are the preferred standard for Gulf of Mexico well operations offshore in the U.S.A. Olefin hydrocarbons are only available from a select group of supply outlets, elevating costs and increasing the scarcity of such synthetic hydrocarbons due to many competing consumers within and outside of the oil & gas industry. Accordingly, elevated C16-C18 hydrocarbons are valuable but costly if derived from petroleum, additionally requiring processing through advanced reactions and distillation. The embodiments herein, employing renewable diesel, instead provide a concentrated source of C16-C18 hydrocarbons by deriving them from natural constituents found in biomass food, plant, and animal wastes.

In some embodiments, the renewable diesel base fluid may have a C18 hydrocarbon content (i.e., all of branched, cyclic, and straight-chained) of greater than about 10% by weight of the renewable diesel base fluid (i.e., by weight of the liquid portion of the renewable diesel base fluid without accounting for the treatment fluid additives), encompassing any value and subset therebetween. In some instances, the renewable diesel base fluid may have a C18 hydrocarbon content in the range of about 10% to about 67.5% by weight of the renewable diesel, encompassing any value and subset therebetween. For example, the C18 hydrocarbon content may be in the range of about 10% to about 21.5%, or about 21.5% to about 33%, or about 33% to about 44.5%, or about 44.5% to about 56%, or about 56% to about 67.5% by weight of the renewable diesel base fluid, encompassing any value and subset therebetween.

In some embodiments, the renewable diesel base fluid may comprise a C17 hydrocarbon content i.e., all of branched, cyclic, and straight-chained) of greater than about 6.5% by weight of the renewable diesel base fluid, encompassing any value and subset therebetween. For example, the renewable diesel base fluid may have a C16 hydrocarbon content in the range of about 6.5% to about 20%, including about 6.5% to about 10%, or 10% to about 12.5%, or about 12.5% to about 15%, or about 15% to about 17.5%, or about 17.5% to about 20% by weight of the renewable base fluid, encompassing any value and subset therebetween.

The renewable diesel base fluid may further comprise a C16 hydrocarbon content (i.e., all of branched, cyclic, and straight-chained) of greater than about 7.5% by weight of the renewable diesel base fluid, encompassing any value and subset therebetween. For example, the renewable diesel base fluid may have a C16 hydrocarbon content in the range of about 7.5% to about 20%, including about 7.5% to about 10%, or 10% to about 12.5%, or about 12.5% to about 15%, or about 15% to about 17.5%, or about 17.5% to about 20% by weight of the renewable base fluid, encompassing any value and subset therebetween.

The renewable diesel base fluid described herein may have a combination thereof, such that the C18 content is greater than about 10%, the C17 content is greater than about 6.5%, and the C16 content is greater than about 7.5%, each by weight of the renewable diesel base fluid. The renewable diesel base fluid may have a C18 content in the range of about 10% to about 67.5%, a C17 content of about 6.5% to about 20%, and a C16 content of about 7.5% to about 20%, each by weight of the renewable diesel base fluid, and encompassing any value and subset therebetween.

Specific examples of the content of the C16-C18 hydrocarbons in the renewable diesel base fluid for use in the embodiments of the present disclosure may be parsed based on branched, straight-chained, or cyclic hydrocarbon content for each of C16-C18. As a specific example, the renewable diesel base fluid may comprise a hydrocarbon content of branched C18 of greater than about 10% by weight of the renewable diesel base fluid. In some instances, the hydrocarbon content of the C18 in the renewable diesel base fluid is in the range of about 10% to about 60% by weight of the renewable diesel base fluid, encompassing any value and subset therebetween. For example, the hydrocarbon content of branched C18 may be in the range of about 10% to about 20%, or about 20% to about 30%, or about 30% to about 40%, or about 50% to about 60%, or about 20% to about 50%, or about 30% to about 40% by weight of the renewable diesel base fluid, without departing from the scope of the present disclosure, encompassing any value and subset therebetween.

As another specific example, in some embodiments, the hydrocarbon content of branched C16 is greater than about 7.5% by weight of the renewable diesel base fluid, including in the range of about 7.5% and about 15%, or about 7.5% to about 10%, or about 7.5% to about 12%, or about 10% to about 15%, or about 10% to about 12% by weight of the renewable diesel base fluid, without departing from the scope of the present disclosure, encompassing any value and subset therebetween. As another specific example, in some embodiments, the hydrocarbon content of branched C17 is greater than about 6.5% by weight of the renewable diesel base fluid, including in the range of about 6.5% to about 15%, or about 6.5% to about 10%, or about 6.5% to about 12%, or about 10% to about 15%, or about 10% to about 12% by weight of the renewable diesel base fluid, without departing from the scope of the present disclosure, encompassing any value and subset therebetween.

Providing additional specific examples, straight-chained C16, C17, and C18 hydrocarbons are also comparatively prominent in the renewable diesels for use as base fluids of the present invention, as compared to traditional petroleum diesel (and biodiesel). In some embodiments, the n-C16, n-C17, and n-C18 are present in an amount in the range of about 1% to about 15% by weight of the renewable diesel base fluid, including in the range of about 1% to about 2.5%, or about 2.5% to about 5%, or about 5% to about 7.5%, or about 7.5% to about 12.5%, or about 12.5% to about 15%, or about 5% to about 12.5%, or about 7.5% to about 10% by weight of the renewable diesel base fluid, without departing from the scope of the present disclosure, encompassing any value and subset therebetween. In some embodiments, the n-C18 may be in greater amount than each of the n-C17 and n-C16, and the n-C17 may be in greater amount than the n-C16.

The renewable diesel base fluid may further comprise cyclic C16-C18 hydrocarbons, without departing from the scope of the present disclosure.

Each of these values for hydrocarbon content provided above is critical to the embodiments of the present disclosure and may depend on a number of factors including, but not limited to, the type and composition of the renewable diesel base fluid, the processing methodology used to form the renewable diesel base fluid, the desired qualities of the renewable diesel (e.g., melting point, hydrophobicity, and the like).

As an example, in some embodiments, the renewable diesel base fluid for use in the embodiments of the present disclosure may have a branched C16 hydrocarbon content of about 11%, a branched C17 content of about 13%, and a branched C18 content of about 54%, each by weight of the renewable diesel base fluid. In some embodiments, the renewable diesel base fluid for use in the embodiments of the present disclosure may have a n-C16 hydrocarbon content of about 2%, a n-C17 content 3.5%, and a n-C18 content of about 7%, each by weight of the renewable diesel base fluid. A combination of these contents is also suitable for use as the renewable diesel base fluids of the present disclosure, including the presence of cyclic C16-C18 hydrocarbons.

In addition to the characteristics described above for the renewable base fluid of the present disclosure, additional characteristics include an absence of aromatic compounds, an absence of sulfur content, and an absence of oxygen. That is, the renewable diesel for use in the embodiments described herein comprises 0% aromatic compounds, 0% sulfur, and 0% oxygen. Such characteristics may be environmentally and operator-safety friendly. Additionally, these characteristics may make reuse, recycling, or disposal less environmentally impactful and less expensive (e.g., processing for disposal is reduced). Further, the various characteristics of the renewable diesel base fluids of the present disclosure permit its use in high temperature wellbore environments, which may be in the range of about 150° C. to about 220° C., encompassing any value and subset therebetween.

In some embodiments, the renewable diesel base fluids described herein may be in the form of an invert emulsion, which may enhance use of the treatment fluid comprising the renewable diesel base fluids in extreme downhole conditions (e.g., high temperatures, pressures, and the like), in operations requiring increased lubricity or corrosion resistance, and the like. As used herein, the term “invert emulsion” refers to an emulsion in which oil is the continuous, external phase and an aqueous fluid is the discontinuous, internal phase. Accordingly, the renewable diesel base fluid forms the external phase and an aqueous fluid forms the internal phase of the invert emulsion. When the renewable oil diesel is in the form of an invert emulsion, suitable aqueous fluids for forming the internal phase may include, but are not limited to, fresh water, saltwater (i.e., water containing one or more salts dissolved therein), brine (i.e., saturated salt water), seawater, produced water (i.e., water produced as a byproduct of a subterranean formation operation), untreated wastewater (i.e., water that has been adversely affected in quality by anthropogenic influence), treated wastewater (i.e., wastewater treated to remove all or a portion of the anthropogenic influence), alcohols in combination with any of the aforementioned aqueous fluids (e.g., methanol, ethanol, n-propanol, isopropanol, n-butanol, sec-butanol, isobutanol, t-butanol, and the like), and any combination thereof. That is, the aqueous fluid may be from any source, provided that it does not contain components that might adversely affect the stability and/or performance of the renewable diesel base fluid or the treatment fluids comprising the renewable diesel base fluids according to the embodiments described herein.

When in invert emulsion form, the ratio of the renewable diesel base fluid:aqueous fluid may be in the range of about 100:1 to about 30:70, encompassing any value and subset therebetween. The ratio may be by volume or weight. For example, the ratio may be in the range of about 100:1 to about 90:10, or about 90:10 to about 80:20, or about 80:20 to about 70:30, or about 70:30 to about 60:40, or about 60:40 to about 50:30, or about 50:30 to about 40:40, or about 40:40 to about 30:70, encompassing any value and subset therebetween. In some embodiments, the invert emulsion may exhibit increased stabilization with an increased about of the renewable diesel base fluid compared to the aqueous fluid. In such embodiments, the ratio may be in the range of between about 100:1 and 70:30, encompassing any value and subset therebetween. In some embodiments, the ratio is about 70:30. Each of these values is critical to the embodiments of the present disclosure and may depend on a number of factors including, but not limited to, the formation operation being performed, the desired stability of the emulsion, the type of aqueous fluid selected, the renewable base fluid selected (e.g., pure, blended with petroleum diesel, and the like), and the like, and any combination thereof.

In other embodiments, the renewable diesel base fluids may be in the form of an oil-in-water emulsion, in which the oil is in the discontinuous, internal phase and an aqueous fluid is in the continuous, external phase. Accordingly, the renewable diesel base fluid forms the internal phase and an aqueous fluid forms the external phase. Such oil-in-water emulsions formed using the renewable diesel base fluids described herein may be low-density fluids suitable for applications such as near-balanced to low-pressure and depleted fractured reservoirs, among other applications. When the renewable diesel base fluid is in the form of an oil-in-water emulsion, any of the aforementioned aqueous fluids discussed above with reference to the invert emulsions described herein may be used as the aqueous fluid for forming the oil-in-water emulsion.

When in oil-in-water emulsion form, the ratio of the renewable diesel base fluid:aqueous fluid may be in the range of about 1:50 to about 50:50, encompassing any value and subset therebetween. The ratio may be by volume or by weight. For example, the ratio may be in the range of about 1:50 to about 10:50, or about 10:50 to about 20:50, or about 20:50 to about 30:50, or about 30:50 to 40:50, or about 40:50 to about 50:50, encompassing any value and subset therebetween. In some embodiments, the ratio may be about 12.5:50, or 80% renewable diesel base fluid by volume of the oil-in-water emulsion, without departing from the scope of the present disclosure. Each of these values is critical to the embodiments of the present disclosure and may depend on a number of factors including, but not limited to, the formation operation being performed, the desired stability of the emulsion, the type of aqueous fluid selected, the renewable base fluid selected (e.g., pure, blended with petroleum diesel, and the like), and the like, and any combination thereof.

In some embodiments, rather than being blended with a petroleum diesel, as described above, the renewable diesel base fluid may be blended with an aqueous fluid, to form a predominantly aqueous-based treatment fluid, where the renewable diesel acts as a lubricant therein, and having the benefits of the renewable diesel base fluid described above. The renewable diesel may serve to lower torque (rotary friction) and drag (axial friction) in the wellbore, lubricate equipment components (e.g., drill bits, bearings), extend the life of the equipment components (e.g., by combating heat, contamination from water and dirt, heavy buildup of sludge, and the like), and the like. Use of the renewable diesel oil for such applications decreases costs and provides a biomass, clean source to enhance lubrication and cleaning of the equipment. Moreover, effective lubrication results in more efficient operations, such as drilling operations, further reducing costs and operational time and personnel.

When the renewable diesel base fluid is blended with an aqueous fluid for use as a lubricant therein, the aqueous fluid may be any of those described above with reference to the invert emulsion (and the oil-in-water emulsion). When the renewable diesel base fluid is blended with an aqueous fluid, it may be included in an amount in the range of about 1% to about 20% by volume of the aqueous fluid, encompassing any value and subset therebetween. For example, the renewable diesel base fluid may be present in an amount of about 1% to about 5%, or about 5% to about 10%, or about 10% to about 15%, or about 15% to about 20% by volume of the aqueous fluid, encompassing any value and subset therebetween. In some embodiments, the renewable diesel base fluid may be present in an amount of about 4% by volume of the aqueous fluid. Each of these values is critical to the embodiments of the present disclosure and may depend on a number of factors including, but not limited to, the subterranean formation operation being performed, the desired lubricity, the type of renewable diesel base fluid selected (e.g., pure, blended with petroleum diesel, and the like), and the like, and any combination thereof.

Moreover, the renewable diesel base fluid described herein may be used as a universal diluent for any liquid additive used in a treatment fluid for use in a subterranean formation operation, including water-based, oil-based, solvent-based, emulsion-based, and the like fluids.

The treatment fluids described herein further comprise a treatment fluid additive. As used herein, the term “treatment fluid additive” (also referred to herein simply as “additive”) refers to a substance included within a treatment fluid to perform on or more specific functions, either in the treatment fluid itself or for performing a particular subterranean formation operation, as described herein. For example, the treatment fluids of the present disclosure may be used during drilling operations and examples of treatment fluid additives used for that purpose may include, but are not limited to, weighting agents, viscosifiers, lubricants, and the like. As another example, when the renewable diesel base fluid is in the form of an invert emulsion or oil-in-water emulsion, an emulsifier may be included for the purpose of enhancing the stability of the invert emulsion or oil-in-water emulsion for performing a particular formation operation.

Examples of suitable treatment fluid additives for use in the embodiments of the present disclosure may include, but are not limited to, an emulsifier, a pH control agent, a viscosifier (including low-shear and high-shear viscosifiers), a crosslinker, a fluid loss control agent, a salt, an alcohol, a weighting agent, an inert solid (e.g., gravel, proppant particulates, and the like), and any combination thereof. Other suitable treatment fluid additives may include, but are not limited to, a dispersion aid, a corrosion inhibitor, a foaming agent, a gas, a breaker, a biocide, a chelating agent, a scale inhibitor, a gas hydrate inhibitor, a clay stabilizing agent, and any combination thereof. Combinations of each of these treatment fluid additives may also be suitable, without departing from the scope of the present disclosure.

An emulsifier additive may be included in the treatment fluids of the present disclosure when the renewable diesel base fluid is in the form of an invert emulsion or oil-in-water emulsion. The emulsifier additives are used to stabilize the droplets of aqueous fluid in the invert emulsion to impart stability thereto, or to stabilize the droplets of the renewable diesel base fluid in the oil-in-water emulsion to impart stability thereto. The emulsifier additive additionally is used to maintain any solids in the invert emulsion or oil-in-water emulsion oil-wet, thus preferring to be in contact with the renewable diesel fluid phase rather than the aqueous fluid phase. Examples of suitable emulsifiers for use in the embodiments of the present disclosure may include, but are not limited to, a fatty acid, a soap of a fatty acid, a polymerized fatty acid, a polyamide, an amido-amine, a polyamine, an oleate ester (e.g., sorbitan monoleate polyethoxylate, sorbitan dioleate polyethoxylate, and the like), an imidazoline, an alcohol, a polyolefin amide, an alkenamide, an ionic surfactant, a non-ionic surfactant, an anionic surfactant, a cationic surfactant, a viscoelastic surfactant, an oxyalkylated phenol, a carboxylate salt of an oxyalkylated phenol, a castor oil ethoxylated with ethylene oxide, and any combination thereof. Suitable commercially available emulsifiers for use in the treatment fluids of the present disclosure may include, but are not limited to, INVERMUL® NT, FORTI-MUL®, LE SUPERMUL®, and EZ MUL® NT, each fatty acid emulsifiers, and each available from Halliburton Energy Services, Inc. in Houston, Tex.

In some embodiments, the emulsifier may be included in the treatment fluids described herein in an amount in the range of about 0.5% to about 7% by volume of the renewable diesel base fluid in the invert emulsion (i.e., by volume of the external phase of the invert emulsion). For example, the emulsifier may be present in an amount in the range of about 0.5% to about 1.8%, or about 1.8% to about 3.1%, or about 3.1% to about 4.4%, or about 4.4% to about 5.7%, or about 5.7% to about 7% by volume of the renewable diesel base fluid in the invert emulsion. In some embodiments, the emulsifier is preferably present in the range of about 1.875% to about 3.625 by volume of the renewable diesel base fluid in the invert emulsion, encompassing any value and subset therebetween. In some embodiments, the emulsifier is present in about 2.75% or about 3% by volume of the renewable diesel base fluid in the invert emulsion Each of these values for the emulsifier is critical to the embodiments of the present disclosure and may depend on a number of factors including, but not limited to, the desired stability of the invert emulsion, the stability of the invert emulsion without the emulsifier, the amount and type of weighting agents in the invert emulsion, the ratio of external phase to internal phase, the subterranean formation operation being performed, the conditions of the subterranean formation environment (e.g., temperature, pressure, and the like), and the like, and any combination thereof.

The pH control agent additive may be included in the treatment fluids described herein to achieve a desired pH for the treatment fluid, which may be based on the functionality of other additives included in the treatment fluid. The pH control agent may be used to neutralize acids that are present due to the inclusion of additives in the treatment fluid or due to natural conditions of the formation (e.g., acid gasses formed by the formation). Examples of suitable pH control agent additives may include any acid or base compounds capable of adjusting the pH of the treatment fluids described herein, including, but not limited to, lime, an alkali metal hydroxide (e.g., sodium hydroxide, potassium hydroxide, and the like), an alkali metal carbonate (e.g., sodium carbonate, potassium carbonate, and the like), a bicarbonate, sulfamic acid, sulfuric acid, hydrochloric acid, sodium bisulfate, and any combination thereof.

In some embodiments, the pH control agent may be included in the treatment fluids described herein in an amount in the range of about 0.1 pounds per barrel (Ib/bbl, where a barrel is equal to 42 U.S. gallons and 158.987 metric liters) to about 15 lb/bbl of the treatment fluid. For example, the pH control agent may be present in the treatment fluids in range of about 0.1 lb/bbl to about 1 lb/bbl, or about 1 lb/bbl to about 3 lb/bbl, or about 3 lb/bbl to about 6 lb/bbl, or about 6 lb/bbl to about 9 lb/bbl, or about 9 lb/bbl to about 12 lb/bbl, or about 12 lb/bbl to about 15 lb/bbl, encompassing any value and subset therebetween. In some embodiments, the pH control agent is present in the range of about 3 lb/bbl to about 9 lb/bbl, encompassing any value and subset therebetween. In some embodiments, the pH control agent is present in the treatment fluids in an amount of about 7.5 lb/bbl. Each of these values for the pH control agent is critical to the embodiments of the present disclosure and may depend on a number of factors including, but not limited to, the desired pH of the treatment fluid, the types of additives included in the treatment fluid, the subterranean formation operation being performed (e.g., effects upon contact with operational equipment), the conditions of the subterranean formation environment (e.g., acidic and/or basic in certain intervals of interest), and the like, and any combination thereof.

The viscosifier additive for use in the treatment fluids described herein may be any substance that increases the viscosity of the treatment fluids (e.g., of the renewable diesel base fluid). In some embodiments, the viscosifier may comprise one or more polymeric or absorbent clay materials that have at least molecules that are capable of forming an internal crosslink or an external crosslink with another viscosifier in a crosslinking reaction in the presence of a crosslinker additive. In some instances, the viscosifier may selectively increase low-shear or high-shear viscosity, which may be particularly beneficial depending on the type of subterranean formation and subterranean formation operation being performed therein. Additionally, one or more viscosifiers may also increase the gel strength of the treatment fluids, without departing from the scope of the present disclosure.

Examples of suitable viscosifiers may include, but are not limited to, a clay (e.g., a phyllosilicate, such as bentonite, laponite, and the like); an organophilic clay (e.g., organophilic bentonite); hydrophobic amines and C36 dimer diamines; polar hydrophobic additives such as pentaerythritol tetrastearate, trimethylol propane trioleate, pentaerythritol tetraoleate; and any combination thereof. Suitable commercially available viscosifiers may include, but are not limited to, GELTONE® products (e.g., GELTONE® II, GELTONE® V, and the like), bentonite viscosifiers, and TAU-MOD™ viscosifier, an amorphous/fibrous viscosifier, each available from Halliburton Energy Services, Inc. in Houston, Tex. Other suitable commercially available viscosifiers may include, but are not limited to, SUSPENTONE™, RM-63198 , and RHEMOD™ L, BDF-568™, each low-shear viscosifiers, and each available from Halliburton Energy Services, Inc. in Houston, Tex.

In some embodiments, the viscosifier additive may be included in the treatment fluids described herein in an amount in the range of about 0.1 pounds per barrel (Ib/bbl, where a barrel is equal to 42 U.S. gallons and 158.987 metric liters) to about 15 lb/bbl of the treatment fluid. For example, the viscosifier may be present in the treatment fluids in range of about 0.1 lb/bbl to about 1 lb/bbl, or about 1 lb/bbl to about 3 lb/bbl, or about 3 lb/bbl to about 6 lb/bbl, or about 6 lb/bbl to about 9 lb/bbl, or about 9 lb/bbl to about 12 lb/bbl, or about 12 lb/bbl to about 15 lb/bbl, encompassing any value and subset therebetween. In some embodiments, the viscosifier agent is present in the range of about 3 lb/bbl to about 9 lb/bbl, encompassing any value and subset therebetween. In some embodiments, the viscosifier is present in the treatment fluids in an amount of about 7.5 lb/bbl. Each of these values for the viscosifier is critical to the embodiments of the present disclosure and may depend on a number of factors including, but not limited to, the desired viscosity of the treatment fluid, the types of additives included in the treatment fluid, the subterranean formation operation being performed, the conditions of the subterranean formation environment (e.g., low-shear or high-shear environment, and the like), and the like, and any combination thereof.

The fluid loss control agents for use in the embodiments of the present disclosure reduce fluid loss, or the amount (e.g., volume) of filtrate that passes through a filter medium, such as a formation. Suitable fluid loss control agents may be any material capable of reducing fluid loss during a subterranean formation operation and may, include, in some instances overlap chemically with the viscosifiers described herein. Examples of suitable fluid loss control agents may include, but are not limited to, a clay, a polymer, an organic polymer, a copolymer, silica flour, a wax, a resin, a lignin, a graft lignin, a lignite, an organophilic lignite, various copolymers and any combination thereof. Examples of commercially available fluid loss control agents for use in the embodiments of the present disclosure may include, but are not limited to, DURATONE® HT, a lignite fluid loss control agent, and ADAPTA® and BDF-454™, polymeric fluid loss control agents, each available from Halliburton Energy Services, Inc. in Houston, Tex.

In some embodiments, the fluid loss control agent additive may be included in the treatment fluids described herein in an amount in the range of about 0.1 pounds per barrel (Ib/bbl, where a barrel is equal to 42 U.S. gallons and 158.987 metric liters) to about 15 lb/bbl of the treatment fluid. For example, the fluid loss control agent may be present in the treatment fluids in range of about 0.1 lb/bbl to about 1 lb/bbl, or about 1 lb/bbl to about 3 lb/bbl, or about 3 lb/bbl to about 6 lb/bbl, or about 6 lb/bbl to about 9 lb/bbl, or about 9 lb/bbl to about 12 lb/bbl, or about 12 lb/bbl to about 15 lb/bbl, encompassing any value and subset therebetween. In some embodiments, the fluid loss control agent is present in the range of about 3 lb/bbl to about 9 lb/bbl, encompassing any value and subset therebetween. In some embodiments, the fluid loss control agent is present in the treatment fluids in an amount of about 5 lb/bbl. Each of these values for the fluid loss control agent is critical to the embodiments of the present disclosure and may depend on a number of factors including, but not limited to, the desired fluid loss control, the types of additives included in the treatment fluid, the subterranean formation operation being performed, the conditions of the subterranean formation environment (e.g., porosity, permeability, and the like), and the like, and any combination thereof.

When the renewable diesel base fluid is in the form of an invert emulsion or an oil-in-water emulsion, a salt additive may be added to the aqueous phase of the invert emulsion to drive osmotic dehydration of a formation (e.g., of a drilled wellbore), thereby additionally enhancing stabilization of sticky or water-sensitive clays to prevent their influx into a wellbore, thus improving mechanical stability in the wellbore. The salt additive, accordingly, may be any salt compound, or ion derived therefrom, (collectively referred to herein as a “salt”) that is capable of driving the desired osmotic process. Examples of suitable salts may include, but are not limited to, an alkali earth metal salt, an alkaline earth metal salt, and any combination thereof. For example, suitable salts may include, but are not limited to, calcium, sodium, or potassium chloride, sulfate, nitrate, nitrite, formate, thiocyanate, and any combination thereof.

In some embodiments, the salt additive may be included in the treatment fluids described herein in an amount which renders the density of the aqueous fluid phase above that of fresh water, typically about 8.5 to about 10.5 lb/gal, encompassing any value and subset therebetween. For example, the density may be about 8.5 lb/gal, about 8.6 lb/gal, about 8.7 lb/gal, about 8.8 lb/gal, about 8.9 lb/gal, about 9.0 lb/gal, about 9.1 lb/gal, about 9.2 lb/gal, about 9.3 lb/gal, about 9.4 lb/gal, about 9.5 lb/gal, about 9.6 lb/gal, about 9.7 lb/gal, about 9.8 lb/gal, about 9.9 lb/gal, about 10.0 lb/gal, about 10.1 lb/gal, about 10.2 lb/gal, about 10.3 lb/gal, about 10.4 lb/gal, or about 10.5 lb/gal. For other applications, the salt additive may be added to full saturation of the aqueous fluid phase. Each of these values for the salt additive is critical to the embodiments of the present disclosure and may depend on a number of factors including, but not limited to, the necessary osmotic dehydration, the types of additives included in the treatment fluid, the conditions of the subterranean formation environment (e.g., the salinity therein), the salinity of the aqueous phase forming the invert emulsion, and the like, and any combination thereof.

In some embodiments, rather than including a salt additive in treatment fluids present in invert emulsion form, an alcohol may be used to achieve the same effects. In some embodiments, the alcohol is a polyol, such as a (C3-C30)hydrocarbon polyol. The alcohol can be a triol, such as a (C3-C10)alkanetriol. The alcohol can be glycerol. In addition, the alcohol and an aqueous fluid may be blended to form an invert emulsion, where the internal aqueous phase can include any suitable amount of one or more water-miscible liquids, such as methanol, ethanol, ethylene glycol, propylene glycol, and the like. Any suitable volume of the invert emulsion can be the internal aqueous phase, such as about 0.1 vol % to about 80 vol %, 10 vol % to about 50 vol %, or about 0.1 vol % or less, or about 1 vol %, 2 vol %, 3 vol %, 4 vol %, 5 vol %, 6 vol %, 8 vol %, 10 vol %, 15 vol %, 20 vol %, 25 vol %, 30 vol %, 35 vol %, 40 vol %, 45 vol %, 50 vol %, 55 vol %, 60 vol %, 65 vol %, 70 vol %, 75 vol %, or about 80 vol % or more, wherein for a used invert emulsion drilling fluid the volume refers to the liquid volume not including drilling cuttings and other insoluble material carried therein. Each of these values are critical to the embodiments herein and may depend on a number of factors including, but not limited to, the desired stability of the invert emulsion, the selected alcohol for inclusion in the treatment fluid, and the like, and any combination thereof.

These alcohols are typically miscible in water. Examples of other suitable alcohols may include, but are not limited to, n-propanol, isopropanol, n-butanol, sec-butanol, isobutanol, t-butanol, glycerol, a glycol (e.g., polyglycols, propylene glycol, diethylene glycol, and the like), a polyglycol amine, a polyol, and the like, and any combination thereof.

The alcohol may be included in the treatment fluids described herein in an amount in the range of about 1 lb/bbl to about 200 lb/bbl of the treatment fluid. For example, the alcohol may be included in the amount of about 1% to about 40% or 40% to about 80%, or about 80% to about 120%, or about 120% to about 160%, or about 160% to about 200%, encompassing any value and subset therebetween. In some embodiments, the alcohol is included in the treatment fluids in an amount of about 60 lb/bbl. Each of these values is critical to the embodiments of the present disclosure and may depend on a number of factors including, but not limited to, the types of additives included in the treatment fluid, the conditions of the subterranean formation environment, the salinity of the aqueous phase forming the invert emulsion, and the like, and any combination thereof.

A weighting agent additive may further be included in the treatment fluids of the present disclosure. The weighting agent is used to increase the density of a treatment fluid, such as to enhance the suspension of solids therein (e.g., of inert solids, drill cuttings for production to the surface, for example), to achieve a specific level of overbalance pressure to hold the wellbore in place and counter formation fluid pressures, and the like. Examples of suitable weighting agents may include, but are not limited to, barite, precipitated barite, submicron precipitated barite, hematite, ilmentite, manganese tetraoxide, galena, calcium carbonate, and any combination thereof. Suitable commercially available weighting agents may include, but are not limited to, BAROID® products (e.g., BAROID® 41), barite weighting agents, available from Halliburton Energy Services, Inc. in Houston, Tex.

In some embodiments, the weighting agent additive may optionally be included in the treatment fluids described herein in an amount in the range of about 0.1% to about 60% by volume of the liquid portion of the treatment fluid. For example, the weighting agent may be present of from about 0.1% to about 12%, or about 12% to about 24%, or about 24% to about 36%, or about 36% to about 48%, or about 48% to about 60% by volume of the liquid portion of the treatment fluids. Each of these values for the weighting agent is critical to the embodiments of the present disclosure and may depend on a number of factors including, but not limited to, the desired density of the treatment fluid, the types of additives included in the treatment fluid, the subterranean formation operation being performed (e.g., drilling, fracturing, completion, and the like), the conditions of the subterranean formation environment (e.g., pressure exerted by the formation fluids into the wellbore), and the like, and any combination thereof.

An inert solid additive may be included in the embodiments herein to achieve any one or more of the above functions described with reference to the previous additives (e.g., fluid loss, increasing density) due to their ability to aggregate or become suspended in a treatment fluid. For example, the inert solid additives may function as bridging agents for fluid loss applications, proppants for propping fractures, gravel for forming gravel packs, and the like. Examples of suitable inert solids may include, but are not limited to, marble, sand, bauxite, ceramic materials, glass materials, polymer materials, polytetrafluoroethylene materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The inert solids may be of any shape including substantially spherical or non-spherical (e.g., fibrous), without departing from the scope of the present disclosure.

Generally, depending at least on the particular subterranean formation operation being performed, the inert solids may have an average particle size distribution (d50) in the range of about 2 mesh to about 2500 mesh on the U.S. Sieve Series, such as about 2 mesh to about 550 mesh, or 2 mesh and about 550 mesh, or about 2 mesh and about 270 mesh, or about 2 mesh and about 100 mesh, or about 2 mesh and about 40 mesh, or about 2 mesh and about 30 mesh, or about 2 mesh and about 16 mesh, without departing from the scope of the present disclosure, encompassing any value and subset therebetween. In some embodiments, the inert solids may have a d50 in the range of about 100 mesh to about 2500 mesh, encompassing any value and subset therebetween. It will be appreciated, however, in certain circumstances, other sizes or mixtures of sizes may be desired and are suitable for practice of the embodiments of the present disclosure. For example, when the inert solid additive is used as a bridging material, it may have d50 in the range of about 16 mesh to about 2500 mesh, encompassing any value and subset therebetween. An example of a suitable commercially available inert solid may include, but is not limited to BARACARB® products (e.g., BARACARB® 5, BARACARB® 25, and the like), bridging agents, available from Halliburton Energy Services, Inc. in Houston, Tex.

In some embodiments, the inert solid additive may be included in the treatment fluids described herein in an amount in the range of about 0.1% to about 60% by volume of the liquid portion of the treatment fluid. For example, the weighting agent may be present of from about 0.1% to about 12%, or about 12% to about 24%, or about 24% to about 36%, or about 36% to about 48%, or about 48% to about 60% by volume of the liquid portion of the treatment fluids. Each of these values for the inert solid is critical to the embodiments of the present disclosure and may depend on a number of factors including, but not limited to, the subterranean formation operation being performed (e.g., drilling, fracturing, completion, and the like), the selected inert solid(s) type, shape, and size, the conditions of the subterranean formation environment, and the like, and any combination thereof.

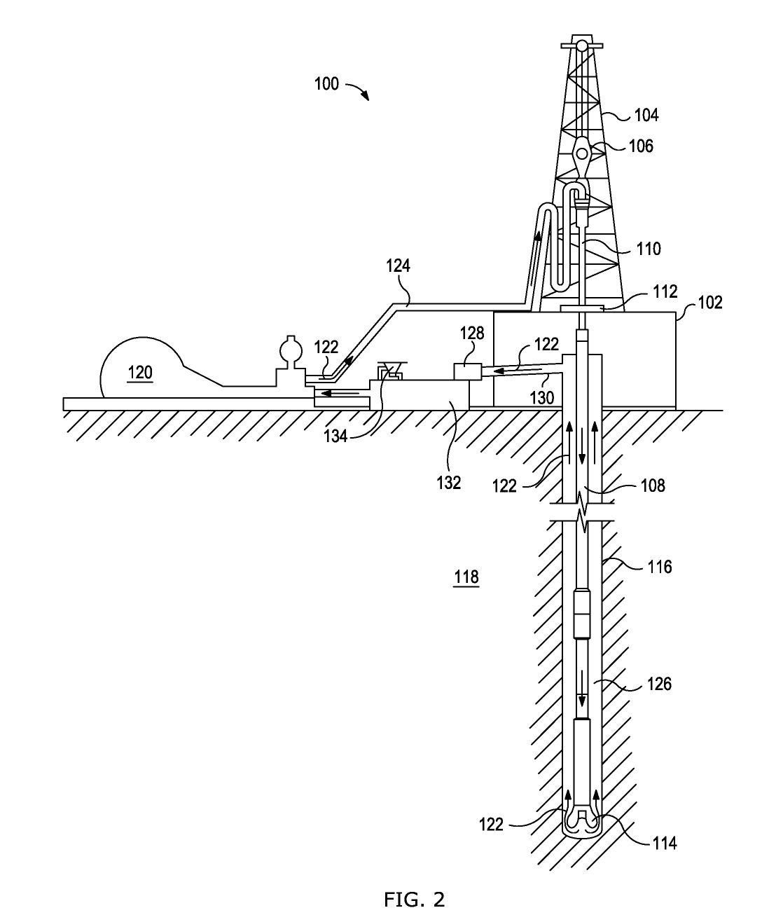

Referring now to FIG. 2, the exemplary treatment fluids disclosed herein may directly or indirectly affect one or more components or pieces of equipment associated with the preparation, delivery, recapture, recycling, reuse, and/or disposal of the disclosed treatment fluids. For example, and with reference to FIG. 2, the disclosed treatment fluids may directly or indirectly affect one or more components or pieces of equipment associated with an exemplary wellbore drilling assembly 100, according to one or more embodiments. It should be noted that while FIG. 2 generally depicts a land-based drilling assembly, those skilled in the art will readily recognize that the principles described herein are equally applicable to subsea drilling operations that employ floating or sea-based platforms and rigs, without departing from the scope of the disclosure. Moreover, while FIG. 2 depicts a drilling operation, it will be appreciated that the embodiments herein, as discussed previously, encompass other subterranean formation operations as well.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed treatment fluids may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed treatment fluids may be added to the drilling fluid 122 at any other location in the drilling assembly 100. In at least one embodiment, for example, there could be more than one retention pit 132, such as multiple retention pits 132 in series.

Moreover, the retention pit 132 may be representative of one or more fluid storage facilities and/or units where the disclosed treatment fluids may be stored, reconditioned, and/or regulated until added to the drilling fluid 122.

As mentioned above, the disclosed treatment fluids may directly or indirectly affect the components and equipment of the drilling assembly 100.

For example, the disclosed treatment fluids may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, The fluid processing unit(s) 128 may further include one or more sensors, gauges, pumps, compressors, and the like used store, monitor, regulate, and/or recondition the exemplary treatment fluids.

The disclosed treatment fluids may directly or indirectly affect the pump 120, which representatively includes any conduits, pipelines, trucks, tubulars, and/or pipes used to fluidically convey the treatment fluids downhole, any pumps, compressors, or motors (e.g., topside or downhole) used to drive the treatment fluids into motion, any valves or related joints used to regulate the pressure or flow rate of the treatment fluids, and any sensors (i.e., pressure, temperature, flow rate, etc.), gauges, and/or combinations thereof, and the like. The disclosed treatment fluids may also directly or indirectly affect the mixing hopper 134 and the retention pit 132 and their assorted variations.

The disclosed treatment fluids may also directly or indirectly affect the various downhole equipment and tools that may come into contact with the treatment fluids such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed treatment fluids may also directly or indirectly affect any downhole heat exchangers, valves and corresponding actuation devices, tool seals, packers and other wellbore isolation devices or components, and the like associated with the wellbore 116. The disclosed treatment fluids may also directly or indirectly affect the drill bit 114, which may include, but is not limited to, roller cone bits, PDC bits, natural diamond bits, any hole openers, reamers, coring bits, etc.

While not specifically illustrated herein, the disclosed treatment fluids may also directly or indirectly affect any transport or delivery equipment used to convey the treatment fluids to the drilling assembly 100 such as, for example, any transport vessels, conduits, pipelines, trucks, tubulars, and/or pipes used to fluidically move the treatment fluids from one location to another, any pumps, compressors, or motors used to drive the treatment fluids into motion, any valves or related joints used to regulate the pressure or flow rate of the treatment fluids, and any sensors (i.e., pressure and temperature), gauges, and/or combinations thereof, and the like.

Embodiments disclosed herein include:

Embodiment A: A method comprising: introducing a treatment fluid into a subterranean formation, the treatment fluid comprising a renewable diesel base fluid and at least one treatment fluid additive, wherein the renewable diesel base fluid comprises in the range of about 10% and about 67.5% C18 hydrocarbons by weight of the base fluid; and performing a subterranean formation operation.

Embodiment B: A treatment fluid comprising: a renewable diesel base fluid comprising in the range of about 10% and about 67.5% C18 hydrocarbons by weight of the base fluid; and at least one treatment fluid additive.

Embodiment C: A system comprising: a tubular extending into a subterranean formation; and a pump fluidly coupled to the tubular, the tubular containing a treatment fluid comprising: a renewable oil base fluid and at least one treatment fluid additive, wherein the renewable diesel base fluid comprises in the range of about 10% and about 67.5% C18 hydrocarbons by weight of the base fluid.

Each of Embodiments A, B and C may have one or more of the following additional elements in any combination:

Element 1: Wherein the treatment fluid is used to perform a subterranean formation operation selected from the group consisting of a drilling operation, a pre-pad treatment operation, a fracturing operation, a pre-flush treatment operation, an after-flush treatment operation, a sand control operation, an acidizing operation, a frac-pack operation, a water control operation, a fluid loss control operation, a wellbore clean-out operation, a lost circulation control operation, a completion operation, and any combination thereof.

Element 2: Wherein the renewable diesel base fluid is in the form of an invert emulsion, wherein the renewable diesel base fluid comprises an external phase and an aqueous fluid comprises an internal phase.

Element 3: Wherein the renewable diesel base fluid is in the form of an invert emulsion, wherein the renewable diesel base fluid comprises an external phase and an aqueous fluid comprises an internal phase, and wherein the ratio of the external phase to the internal phase is about 100:1 to about 30:70.

Element 4: Wherein the renewable diesel base fluid is in the form of an oil-in-water emulsion, wherein the renewable diesel base fluid comprises an internal phase and an aqueous fluid comprises an external phase.

Element 5: Wherein the treatment fluid further comprises an aqueous fluid, and wherein the renewable diesel base fluid is present in an amount of about 1% to about 20% by volume of the aqueous fluid.

Element 6: Wherein the treatment fluid additive is selected from the group consisting of an emulsifier, a pH control agent, a viscosifier, a crosslinker, a fluid loss control agent, a salt, a weighting agent, an inert solid, a dispersion aid, a corrosion inhibitor, a foaming agent, a gas, a breaker, a biocide, a chelating agent, a scale inhibitor, a gas hydrate inhibitor, a clay stabilizing agent, and any combination thereof.

Element 7: Wherein the renewable diesel base fluid comprises in the range of about 7.5% and about 20% C16 hydrocarbons by weight of the base fluid.

Element 8: Wherein the renewable diesel base fluid comprises in the range of about 6.5% and about 20% C17 hydrocarbons by weight of the base fluid.

Element 9: Wherein the renewable diesel base fluid comprises a straight-chained hydrocarbon selected from the group consisting of n-C16, n-C17, n-C18, and any combination thereof in in the range of about 2% to about 15% by weight of the base fluid.

By way of non-limiting example, exemplary element combinations applicable to Embodiment A, B and/or C include: 1, 2, and 9; 3, 5, 6, and 8; 2, 4, and 7; 5, 6, 7, and 9; 4 and 8; 5, 7, and 9; and the like; and any combination thereof.

To facilitate a better understanding of the embodiments of the present invention, the following examples of preferred or representative embodiments are given. In no way should the following examples be read to limit, or to define, the scope of the invention.

### EXAMPLE 1

A battery of tests were conducted to evaluate the use of a biodiesel, specifically a fatty acid methyl ester (“FAME”) biodiesel, for use as the base fluid in an biodiesel oil-based drilling treatment fluid (“bOBDF”) for use in a drilling operation compared to a petroleum diesel, specifically #2 diesel, for use as the base fluid in an petroleum oil-based drilling treatment fluid (“pOBDF”) for use in a drilling operation. The pOBDF was prepared to illustrate the typical behavior of a relaxed-filtrate oil-based treatment fluid formulation.

Four bOBDFs and one pOBDF were prepared according to Table 1 below, each having about a 15 pound per gallon (lb/gal) density and each diesel oil component was present in an invert emulsion form having an 85:15 oil-to-water ratio. The biodiesel selected was a FAME biodiesel available from Blue Sun Corporation in Golden, Colo. Two different Blue Sun Biodiesel types were evaluated: Blue Sun B100 and Blue Sun B50, where the “100” refers to 100% biodiesel and the “50” refers to a blend where 50% is biodiesel (represented by the “50” in B50) and 50% is petroleum diesel. REV DUST® is a ground calcium montmorillonite clay used to simulate drill cuttings in laboratory experimentation, and is available from Milwhite, Inc. in Brownsville, Tex. The unit “bbl” refers to barrel, where a barrel is equivalent to 42 gallons (also equivalent to 0.1589 cubic meters). The unit “Ib” refers to pounds (also equivalent to 453.592 grams). The notation “--” means that the particular component was not included.

TABLE 1

| | | bOBDF | bOBDF | bOBDF | bOBDF |
|---|---|---|---|---|---|
| Component | pOBDF | 1 | 2 | 3 | 4 |
| #2 Diesel (bbl) | 0.575 | — | — | — | — |
| B50 biodiesel (bbl) | — | 0.575 | 0.575 | — | — |
| B100 biodiesel (bbl) | — | — | — | 0.575 | 0.575 |
| INVERMUL ® NT | 2 | 2 | 2 | 2 | 2 |
| emulsifier (lb) | | | | | |
| EZ MUL ® NT | 6 | 6 | 6 | 6 | 6 |
| emulsifier (lb) | | | | | |
| Lime (lb) | 1 | 1 | 5 | 1 | 1 |
| GELTONE ® II | 3 | 1 | 2 | 1 | — |
| viscosifier (lb) | | | | | |
| DURATONE ® HT | 1 | 1 | 1 | 1 | 1 |
| fluid loss | | | | | |
| control agent (lb) | | | | | |
| Fresh Water (bbl) | 0.103 | 0.103 | 0.103 | 0.103 | 0.103 |
| Calcium chloride | 20.4 | 20.4 | 20.3 | 20.4 | 20.4 |
| salt (lb) | | | | | |
| BAROID ® 41 | 357 | 357 | 355 | 357 | 357 |
| weighting agent (lb) | | | | | |
| REV DUST ® clay (lb) | 30 | 30 | 30 | 30 | 30 |

Using a FANN® Multi-Mixer, 350 milliliters (mL) samples of each of the treatment fluids were mixed for 45 minutes at about 12,000 rpm and at room temperature. The samples were then hot rolled in glass jars at 150° F. (65.56° C.) for 16 hours to condition the mixtures and simulate formation conditions.

After hot rolling, rheology data was for the samples obtained using a FANN® 35A Viscometer (R1 rotor, B1 bob, and F1 torsion) at 120° F. (48.89° C.) by measuring the shear stress of the bob at shear rates between 3 rpm to 600 rpm (units: lb/100ft²), determining the plastic viscosity (PV) (units: centipoise (cP)) and the yield point (YP) (units: lb/100ft²). The PV is determined by subtracting the 300 rpm shear stress from the 600 rpm yield stress. The YP is determined by subtracting the PV from the 300 rpm shear stress. The 10 second (s) gel and 10 minute (min) gel were measured by allowing TF1 to remain static for 10-sec or 10-min, respectively, and, then, measuring the maximum deflection at 3 rpm with the FANN® 35A Viscometer (units: lb/100ft²).

The electrical stability (units: volts) of each treatment fluid was measured using a FANN® Model 23E Electrical Stability Tester at 120° F. (48.89° C.) to evaluate the emulsion stability and oil-wetting capacity of the fluids.

The high pressure, high temperature (HPHT) filtration control (i.e., fluid loss) (units: mL) of the treatment fluids was tested on a FANN® HPHT Filter Press with an API standard filter paper (6.35 centimeter (cm) (i.e., 2.5 inch) diameter). Filtrate was collected in a graduated cylinder with the fluid sample held at 250° F. (121.11° C.) and 500 psi differential pressure for 30 minutes. The volume of fluid collected was multiplied by 2 to give the HPHT filtrate value (or fluid loss volume amount). The results are reported in Table 2 below.

TABLE 2

| | pOBDF | bOBDF 1 | bOBDF 2 | bOBDF 3 | bOBDF 4 |
|---|---|---|---|---|---|
| 600 rpm | 54 | 65 | 81 | 112 | 130 |
| 300 rpm | 31 | 40 | 60 | 73 | 87 |
| 200 rpm | 20 | 29 | 57 | 56 | 70 |
| 100 rpm | 13 | 19 | 54 | 37 | 50 |
| 6 rpm | 6 | 7 | 25 | 15 | 21 |
| 3 rpm | 4 | 6 | 24 | 13 | 19 |
| Plastic | 23 | 25 | 19 | 39 | 43 |
| Viscosity | | | | | |
| Yield Point | 8 | 15 | 41 | 34 | 44 |
| 10-sec gel | 4 | 7 | 23 | 14 | 19 |
| 10-min gel | 7 | 8 | 27 | 15 | 19 |
| Electrical | 680 | 575 | 54 | 950 | 900 |
| stability | | | | | |
| HPHT filtrate | 34 | 30 | — | 36 | — |

pOBDF exhibited adequate rheology after 150° F. hot rolling for drilling operations. bOBDF 1 exhibited similar rheological properties as compared to pOBDF after 150° F. hot rolling and, thus, exhibited adequate properties for drilling operations.

bOBDF 2 fluid comprises increased lime content compared to bOBDF 1, simulating contact of the fluid with cement as is often included when the fluid is expected to contact downhole acidic gasses. The increase in lime concentration led to a failure after the 150° F. hot roll. The rheology was higher than desirable, and the emulsion broke to leave water-wet solids. The electrical stability value was only 54 volts, considered far too low at least for drilling operations. Industry standards may vary, yet it is known to those skilled that an ES value below 200 volts indicates minimum emulsion stability.

bOBDF 3 comprising B100 biodiesel was formed using the same formulation as bOBDF 1 comprising B50 biodiesel. After 150° F. hot rolling, the rheological properties of bOBDF 3 were elevated compared to bOBDF 1, which is less desirable. bOBDF 4 was prepared according to bOBDF 3 (with B100 biodiesel), but without GELTONE® II organophilic clay viscosifier, and the rheology profile still exhibited elevated results compared to the B50 readings or the petroleum diesel-only readings. Thus, the viscosity of the biodiesel is generally higher than desired, particularly for B100 fluids, and if higher amounts of water and/or other components (e.g., solids) were added to these fluids they would not be suitable for use as a drilling fluid.

### EXAMPLE 2

Each of pOBDF and bOBDF 1 were hot rolled further at 250° F. after hot rolling at 150° F., as described in Example 1, thus simulating elevated temperatures in a formation, which drilling operations are often performed. The rheology data was evaluated using the same parameters as described in Example 1, and the results are shown in Table 3 below.

TABLE 3

| | pOBDF | bOBDF 1 |
|---|---|---|
| 600 rpm | 113 | 137 |
| 300 rpm | 68 | 102 |
| 200 rpm | 51 | 85 |
| 100 rpm | 33 | 62 |
| 6 rpm | 11 | 30 |
| 3 rpm | 7 | 24 |
| Plastic Viscosity | 45 | 35 |
| Yield Point | 23 | 67 |
| 10-sec gel | 9 | 25 |
| 10-min gel | 14 | 26 |
| Electrical stability | 620 | 245 |
| HPHT filtrate | 22 | 48 |

As shown, pOBDF exhibited adequate and stable rheological properties at the elevated temperature, exhibiting retained emulsion stability and oil-wet solids. Conversely, bOBDF 1 showed excessive viscosity at the elevated temperature, with a yield point result of 67 which is typically too high for normal use in a drilling operation. Typically, a yield point of 35-40 is considered by most in the industry to be the highest acceptable range for a normal drilling fluid. The emulsion stability of bOBDF also dropped to approximately half its initial value shown in Table 2, and water-wetting of solids was observed; this would cause the bOBDF 1 to separate and fail in a real drilling operation. The filtrate volume of bOBDF 1 increased by about 60%, which also indicates destabilization.

### EXAMPLE 2

It was hypothesized that, due to alkaline hydrolysis, FAME biodiesels may be unstable for use in a typical drilling fluid formulation or typical field drilling operation because their breakdown into fatty acids and short-chain alcohols poses both health and safety hazards, as well as performance issues in the drilling environment, particularly at elevated temperatures. Accordingly, to test this hypothesis, a small addition of FAME was added to a stable low aromatic mineral oil-based drilling fluid formulation (bOBDF 5) and compared to a low aromatic mineral oil-based drilling fluid formation without FAME (“Control 1”) (Table 2). The mineral oil selected was ESCAID 110®, available from ExxonMobil Chemical in Irving, Tex. The seawater contamination was purchased from Lake Products Company LLC in Florissant, Mo. as ASTM D1141-98 grade seawater formed by dissolving 41.95 grams of standard sea salt in de-ionized water to make up a volume of one liter. The final density of the solution was 1.02 sg.

The formulations for Control 1 and bOBDF 5 are shown in Table 4 below, each having about a 14 lb/gal density and each oil component was present in an invert emulsion form having an 80:20 oil-to-water ratio.

TABLE 4

| Component | Control 1 | bOBDF 5 |
|---|---|---|
| ESCAID 110 ® (bbl) | 0.52 | 0.50 |
| B100 biodiesel (bbl) | — | 0.02 |
| INVERMUL ® NT emulsifier (lb) | 4 | 4 |
| EZ MUL ® NT emulsifier (lb) | 14 | 14 |
| Lime (lb) | 3 | 3 |
| ADAPTA ® fluid loss control agent (lb) | 3 | 3 |
| DURATONE ® HT fluid loss control agent (lb) | 10 | 10 |
| GELTONE ® V viscosifier (lb) | 5 | 5 |
| SUSPENTONE ™ viscosifier (lb) | 5 | 5 |
| RM-63 ™ viscosifier (lb) | 0.5 | 0.5 |
| Fresh Water (bbl) | 0.143 | 0.143 |
| Calcium chloride salt (lb) | 17.4 | 17.4 |
| BAROID ® weighting agent (lb) | 331 | 331 |
| BARACARB ® 5 inert solid (lb) | 5 | 5 |
| Seawater contamination (bbl) | 0.11 | 0.11 |

Using a FANN® Multi-Mixer, 350 milliliters (mL) samples of Control 1 and bOBDF 5 were mixed for 45 minutes at about 12,000 rpm and at room temperature. The samples were then hot rolled in steel aging cells at 350° F. (176.67° C.) for 16 hours to condition the mixtures and simulate formation conditions. The HPHT filtrate was determined using the same parameters according to Example 1, except at a temperature of 350° F. The results are shown in Table 5 below.

TABLE 5

| | Control 1 | bOBDF 5 |
|---|---|---|
| HPHT filtrate | 3.6 | 12.6 |
| HPHT water breakout (mL) | 0.0 | 1.0 |

As shown, Control 1 showed good properties at the high temperature testing and pressure testing. Since drilling fluids must contend with a number of potential contaminants in its normal application, it is commonplace to add additional water to the internal phase combined with heat stress to gauge the health of the emulsion and suitability of the treatment fluid to stand up to harsh conditions. The addition of 2% volume B100 biodiesel, forming bOBDF 5, did not cause any apparent issues with the rheology or emulsion stability of the fluid when measured at normal conditions. However, the combination of seawater contamination and heat stress to 350° F. did cause the HPHT filtrate to break down, resulting in water breakout of 1.0 mL.

In the HPHT filtration test, the fluid must seal off special filter paper at high temperature and pressure differential to simulate the action of fluid downhole when penetrating new formations. This stresses the invert emulsion since the fluid must build an impermeable seal and allow only a small volume of oil to penetrate through. If the emulsion strength is not robust, water droplets can also penetrate through and affect the formation by water-wetting it and hydrating clays. This could also potentially block producing formations or damage the near wellbore and cause formation evaluation issues. bOBDF exhibited both a steep increase in the filtrate volume and water breakout in the filtrate.

### EXAMPLE 3

In this example, the use of commercially available renewable diesel in an oil-based treatment fluid invert emulsion was evaluated. Commercially available REG-9000™/HRD renewable diesel, available from Renewable Energy Group, Inc. in Ames, Iowa was used. A treatment fluid (TF1) comprising a renewable diesel base fluid was prepared according to Table 6, where each component was added individually or simultaneously where the “Mix Time” column is merged in Table 6, and mixed for the allotted time in minutes before the next component was added. In this example, the components forming the treatment fluid were mixed using a Silverson Mixer at room temperature and at 6,000 rpm. TF1 was formulated to have about a 12 lb/gal density and the renewable diesel component was present in an invert emulsion form having a 75:25 oil-to-water ratio, where the water phase salinity was 250,000 ppm.

TABLE 6

| Component | TF1 | Mix Time |
|---|---|---|
| REG-9000/HRD renewable diesel (bbl) | 151.93 | 5 |
| EZ MUL ® NT emulsifier (lb) | 12 | |
| Lime (lb) | 6 | 10 |
| ADAPTA ® fluid loss control agent (lb) | 4 | 10 |
| Calcium chloride salt (lb) | 23.9 | 5 |
| Fresh Water (bbl) | 68.82 | |
| GELTONE ® II viscosifier (lb) | 8 | 10 |
| BARACARB ® 5 inert solid (lb) | 10 | 5 |
| RM-63 ™ viscosifier (lb) | 1.5 | 5 |
| BAROID ® weighting agent (lb) | 217.84 | 5 |

Samples of TF1 were tested either (1) immediately, (2) after hot rolling at 325° F. (162.78° C.) for 16 hours (hr), or (3) after hot rolling at 325° F. for 16 hr followed by static aging at 325° F. at either 24 hr, 48 hr, or 72 hr, as indicated below. The properties were evaluated using the same parameters as described in Example 1. The results are shown in Table 7 below.

TABLE 7

| | TF1 | | | | |
|---|---|---|---|---|---|
| Hot Rolled @ 325° F. (hr) | — | 16 | | | |
| Static Aged @ 325° F. (hr) | — | — | 24 | 48 | 72 |
| 600 rpm | 106 | 71 | 67 | 85 | 83 |
| 300 rpm | 69 | 41 | 37 | 48 | 45 |
| 200 rpm | 57 | 30 | 26 | 34 | 32 |
| 100 rpm | 43 | 19 | 16 | 18 | 18 |
| 6 rpm | 29 | 6 | 4 | 4 | 4 |
| 3 rpm | 29 | 5 | 3 | 3 | 3 |
| Plastic Viscosity | 37 | 30 | 30 | 37 | 38 |
| Yield Point | 32 | 11 | 7 | 11 | 7 |
| 10-sec gel | 40 | 8 | 6 | 6 | 5 |
| 10-min gel | 44 | 11 | 10 | 10 | 10 |
| Electrical stability | 873 | 589 | 431 | 389 | 366 |

As shown in Table 7, TF1 having the renewable diesel base fluid has long-term stability at 325° F. The properties of TF1 were stable and the emulsion showed no signs of any breakdown after a total of 88 hours, nearly four days total. These results, when compared with Examples 1 and 2 above, far surpass the stability of the similar treatment fluids built with biodiesel or biodiesel blends.

### EXAMPLE 4

In this example, the use of commercially available renewable diesel in an oil-based treatment fluid invert emulsion was evaluated using a different formulation and under different conditions than Example 3. Three treatment fluids (TF2-TF4) comprising a renewable diesel base fluid were prepared according to Table 8, with mixing performed as explained in Example 3. In this example, the components forming the treatment fluids were mixed using a FANN® Multi-Mixer at room temperature and about 12,000 rpm. TF2-TF4 were formulated to have about a 12 lb/gal density and the renewable diesel component was present in an invert emulsion form having a 65:35 oil-to-water ratio, where the water phase salinity was 250,000 ppm. The drill solids were REV-DUST@ clay.

TABLE 8

| Component | TF2 | TF3 | TF4 | Mix Time |
|---|---|---|---|---|
| REG-9000/HRD renewable | 135.57 | 135.57 | 135.57 | 5 |
| diesel (bbl) | | | | |
| FORTI-MUL ® emulsifier (lb) | 9 | 9 | 9 | |
| Lime (lb) | 2 | 2 | 2 | 10 |
| ADAPTA ® fluid loss | 2 | 2 | 2 | 10 |
| control agent (lb) | | | | |
| Calcium chloride salt (lb) | 34.26 | 34.26 | 34.26 | 5 |
| Fresh Water (bbl) | 98.67 | 98.67 | 98.67 | |
| RHEMOD ™ L viscosifier (lb) | 2 | 2 | 2 | 10 |
| TAU-MOD ™ viscosifier (lb) | 4 | 4 | 4 | 5 |
| BAROID ® 41 weighting | 216.49 | 216.49 | 216.49 | 5 |
| agent (lb) | | | | |
| Seawater contamination | — | 10 | — | 15 |
| (% by volume) | | | | |
| Drill solids (lb) | — | — | 42 | 15 |

Samples of TF2-TF4 were tested either (1) immediately (before hot rolling (“BHR”)), or (2) after hot rolling at 250° F. for 16 hours (hr) (after hot rolling (“AHR”)), as indicated below. The properties were evaluated using the same parameters as described in Example 1, except that a 30-min gel value was also determined in some instances. The results are shown in Table 9 below.

TABLE 9

| | TF2 | | TF3 | | TF4 | |
|---|---|---|---|---|---|---|
| | BHR | AHR | BHR | AHR | BHR | AHR |
| 600 rpm | 89 | 88 | 107 | 105 | 106 | 178 |
| 300 rpm | 61 | 58 | 73 | 70 | 77 | 105 |
| 200 rpm | 49 | 48 | 59 | 57 | 60 | 85 |
| 100 rpm | 35 | 34 | 43 | 42 | 42 | 50 |
| 6 rpm | 13 | 15 | 16 | 18 | 19 | 34 |
| 3 rpm | 11 | 13 | 13 | 16 | 17 | 33 |
| Plastic Viscosity | 28 | 30 | 34 | 35 | 29 | 73 |
| Yield Point | 33 | 28 | 39 | 35 | 48 | 32 |
| 10-sec gel | 12 | 16 | 14 | 17 | 21 | 40 |
| 10-min gel | 14 | 24 | 16 | 23 | 25 | 47 |
| 30-min gel | — | 25 | — | 23 | — | 48 |
| Electrical stability | 215 | 441 | 194 | 245 | 209 | 267 |
| HPHT Filtrate | — | 0.8 | — | 0.8 | — | 3.4 |

As shown in Table 9, treatment fluids comprising renewable diesel base fluids can be used in organoclay free systems without reducing their range of capability. TF3 and TF4 having seawater and drill solids, respectively, contaminants show the treatment fluids remain stable and could be used in drilling applications, among other subterranean formation operations.

### EXAMPLE 5

In this example, the use of commercially available renewable diesel in an oil-based treatment fluid invert emulsion (TF5) was evaluated and compared to a control having #2 diesel petroleum oil base fluid (Control 2). TF5 was prepared according to Table 10, with mixing performed as explained in Example 3. In this example, the components forming TF5 and Control 2 were mixed using a FANN® Multi-Mixer at room temperature and about 12,000 rpm. Control 2 and TF5 were formulated to have about a 10 lb/gal density and the oil component was present in an invert emulsion form having a 75:25 oil-to-water ratio, where the water phase salinity was 200,000 ppm.

TABLE 10

| | | | Mix |
|---|---|---|---|
| Component | Control 2 | TF5 | Time |
| #2 Diesel (bbl) | 180.26 | — | 0 |
| REG-9000/HRD renewable | — | 167.66 | |
| diesel (bbl) | | | |
| INVERMUL ® NTemulsifier (lb) | 6 | 6 | 10 |
| EZ MUL ® NT emulsifier (lb) | 4 | 4 | |
| Lime (lb) | 6 | 6 | 10 |
| Calcium chloride salt in | 19.32/74.38 | 19.12/74.59 | 5 |
| fresh water (lb/lb) | | | |
| GELTONE ® II viscosifier (lb) | 6 | 6 | 10 |
| DURATONE ® HT fluid | 8 | 8 | 10 |
| loss control agent (lb) | | | |
| BARACARB ® 5 inert solid (lb) | 10 | 10 | 5 |
| BARACARB ® 25 inert solid (lb) | 20 | 20 | 5 |
| BAROID ® weighting agent (lb) | 59.03 | 72.62 | 5 |
| REV DUST ® clay (lb) | 27 | 27 | |

Samples of Control 2 and TF5 were tested either (1) immediately (BHR), or (2) after hot rolling at 200° F. (93.33° C.) for 16 hours (hr) (AHR), as indicated below. The properties were evaluated using the same parameters as described in Example 1, except that the rpm readings, plastic viscosity, and yield point were evaluated at 150° F. (65.56° C.), and the HPHT filtrate was collected at 200° F. (93.33° C.). Additionally, the lowest value of yield point (“LSYP”) was recorded. The results are shown in Table 11 below.

TABLE 11

| | |
|---|---|
| Control 2 | TF5 |

| | BHR | AHR | BHR | AHR |
|---|---|---|---|---|
| 600 rpm | 70 | 63 | 57 | 59 |
| 300 rpm | 51 | 44 | 37 | 40 |
| 200 rpm | 43 | 36 | 28 | 29 |
| 100 rpm | 33 | 27 | 19 | 21 |
| 6 rpm | 20 | 14 | 10 | 10 |
| 3 rpm | 18 | 13 | 9 | 9 |
| Plastic Viscosity | 19 | 19 | 20 | 19 |
| Yield Point | 32 | 25 | 17 | 21 |
| LSYP | 16 | 12 | 11 | 11 |
| 10-sec gel | 20 | 15 | 13 | 12 |
| 10-min gel | 27 | 16 | 19 | 18 |
| HPHT Filtrate | — | 2.4 | — | 1.4 |
| Electrical stability | 575 | 590 | 536 | 596 |

A direct comparison of petroleum diesel and renewable diesel for use as a base fluid in a treatment fluid is shown in Table 11. The fluid properties were comparable in every respect, meaning that renewable diesel can be used as an immediate substitute and/or replacement for petroleum diesel with no, or minimal concern, for reformulating currently used fluids or their various additive packages. As 6 lb/bbl lime was present in both fluids this shows that renewable diesel tolerates alkalinity in a way which biodiesel cannot.

Therefore, the present disclosure is well adapted to attain the ends and advantages mentioned as well as those that are inherent therein. The particular embodiments disclosed above are illustrative only, as they may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The embodiments illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
introducing a treatment fluid into a subterranean formation, the treatment fluid comprising a renewable diesel base fluid and at least one treatment fluid additive,
wherein the renewable diesel base fluid comprises in the range of about 10% and about 67.5% C18 hydrocarbons by weight of the base fluid; and
performing a subterranean formation operation.

2. The method of claim 1, wherein the renewable diesel base fluid is in the form of an invert emulsion, wherein the renewable diesel base fluid comprises an external phase and an aqueous fluid comprises an internal phase.

3. The method of claim 1, wherein the subterranean formation operation is selected from the group consisting of a drilling operation, a pre-pad treatment operation, a fracturing operation, a pre-flush treatment operation, an after-flush treatment operation, a sand control operation, an acidizing operation, a frac-pack operation, a water control operation, a fluid loss control operation, a wellbore clean-out operation, a lost circulation control operation, a completion operation, and any combination thereof.

4. The method of claim 1, wherein the treatment fluid additive is selected from the group consisting of an emulsifier, a pH control agent, a viscosifier, a crosslinker, a fluid loss control agent, a salt, a weighting agent, an inert solid, a dispersion aid, a corrosion inhibitor, a foaming agent, a gas, a breaker, a biocide, a chelating agent, a scale inhibitor, a gas hydrate inhibitor, a clay stabilizing agent, and any combination thereof.

5. The method of claim 1, wherein the renewable diesel base fluid comprises in the range of about 7.5% and about 20% C16 hydrocarbons by weight of the base fluid.

6. The method of claim 1, wherein the renewable diesel base fluid comprises in the range of about 6.5% and about 20% C17 hydrocarbons by weight of the base fluid.

7. The method of claim 1, wherein the renewable diesel base fluid comprises a straight-chained hydrocarbon selected from the group consisting of n-C16, n-C17, n-C18, and any combination thereof in in the range of about 2% to about 15% by weight of the base fluid.

8. A treatment fluid comprising:
a renewable diesel base fluid comprising in the range of about 10% and about 67.5% C18 hydrocarbons by weight of the base fluid; and
at least one treatment fluid additive.

9. The treatment fluid of claim 8, wherein the renewable diesel base fluid is in the form of an invert emulsion, wherein the renewable diesel base fluid comprises an external phase and an aqueous fluid comprises an internal phase.

10. The treatment fluid of claim 8, wherein the renewable diesel base fluid is in the form of an invert emulsion, wherein the renewable diesel base fluid comprises an external phase and an aqueous fluid comprises an internal phase, and wherein the ratio of the external phase to the internal phase is about 100:1 to about 30:70.

11. The treatment fluid of claim 8, wherein the renewable diesel base fluid is in the form of an oil-in-water emulsion, wherein the renewable diesel base fluid comprises an internal phase and an aqueous fluid comprises an external phase.

12. The treatment fluid of claim 8, further comprising an aqueous fluid, and wherein the renewable diesel base fluid is present in an amount of about 1% to about 20% by volume of the aqueous fluid.

13. The treatment fluid of claim 8, wherein the treatment fluid additive is selected from the group consisting of an emulsifier, a pH control agent, a viscosifier, a crosslinker, a fluid loss control agent, a salt, a weighting agent, an inert solid, a dispersion aid, a corrosion inhibitor, a foaming agent, a gas, a breaker, a biocide, a chelating agent, a scale inhibitor, a gas hydrate inhibitor, a clay stabilizing agent, and any combination thereof.

14. The treatment fluid of claim 8, wherein the renewable diesel base fluid comprises in the range of about 7.5% and about 20% branched C16 hydrocarbons by weight of the base fluid.

15. The treatment fluid of claim 8, wherein the renewable diesel base fluid comprises in the range of about 6.5% and about 20% branched C17 hydrocarbons by weight of the base fluid.

16. A system comprising:
a tubular extending into a subterranean formation; and
a pump fluidly coupled to the tubular, the tubular containing a treatment fluid comprising: a renewable oil base fluid and at least one treatment fluid additive,
wherein the renewable diesel base fluid comprises in the range of about 10% and about 67.5% C18 hydrocarbons by weight of the base fluid.

17. The system of claim 16, wherein the renewable diesel base fluid is in the form of an invert emulsion, wherein the renewable diesel base fluid comprises an external phase and an aqueous fluid comprises an internal phase.

18. The system of claim 16, wherein the renewable diesel base fluid is in the form of an invert emulsion, wherein the renewable diesel base fluid comprises an external phase and an aqueous fluid comprises an internal phase, and wherein the ratio of the external phase to the internal phase is about 100:1 to about 30:70.

19. The system of claim 16, wherein the renewable diesel base fluid comprises in the range of about 7.5% and about 20% branched C16 hydrocarbons by weight of the base fluid.

20. The system of claim 16, wherein the renewable diesel base fluid comprises in the range of about 6.5% and about 20% branched C17 hydrocarbons by weight of the base fluid.
